(19) United States
(12) Patent Application Publication
(10) Pub. No.: US 2004/0158694 A1
(43) Pub. Date: Aug. 12, 2004

(54) Method and apparatus for hazard detection and management in a pipelined digital processor

(76) Inventors: Thomas J. Tomazin, Austin, TX (US); David Witt, Austin, TX (US); Murali Chinnakonda, Austin, TX (US); William H. Hooper, Austin, TX (US)

Correspondence Address: William R. McClellan, Wolf, Greenfield & Sacks, P.C., 600 Atlantic Avenue, Boston, MA, 02210, US

(21) Appl. No.: 10/361,288

(22) Filed: Feb. 10, 2003

(51) Int. Cl. G06F 9/30

(52) U.S. Cl. 712/225

(57) ABSTRACT

Methods and apparatus are provided for use in a digital processor having a pipeline for executing instructions. The method includes monitoring instructions in the pipeline for instructions that write to a resource and instructions that read from the resource; for each instruction that writes to the resource, storing a write instruction type and write instruction tracking data; for each instruction that reads from the resource, determining a read instruction type and generating a latency value based on the write instruction type and the read instruction type; and stalling execution of the instruction that reads from the resource by a number of stall cycles in response to the latency value and the write instruction tracking data.

### FIELD OF THE INVENTION

The present invention relates to digital processors and, more particularly, to methods and apparatus for hazard detection and management in pipelined digital processors.

### BACKGROUND OF THE INVENTION

Many digital processors have pipelines. In a pipeline, the hardware used to execute instructions is divided into a series of stages. For example, one stage may fetch operands, a second stage may carry out an arithmetic operation, and a third stage may store the results. Instructions are loaded into the pipeline and proceed through successive stages of the pipeline on successive clock cycles.

One advantage of a pipeline is that an instruction can be started (i.e., decoding of an instruction can begin) before previous instructions are completed. Thus, several instructions may be in different stages of execution simultaneously. This approach is commonly referred to as “pipelining”. For example, in the three-stage pipeline discussed above, a first instruction may be supplied to the fetch operand stage, and after the first instruction exits the fetch operand stage, a second instruction may be supplied to the fetch operand stage while the first instruction is being processed in the next stage. Pipelining improves throughput and thereby improves the level of performance of the processor.

There are, however, potential hazards associated with starting an instruction before previous instructions complete. One type of hazard arises in instances where an instruction uses the result of a previous instruction. Such instances are referred to herein as “read-after-write” (RAW) dependencies. These dependencies must be detected and appropriately managed so as to ensure that the order in which data is stored and accessed does not differ from the order that would occur without pipelining. Otherwise errors may result, as further discussed below.

The following instruction sequence shows an example of a RAW dependency:

R0=R1*R2

R3=R0+R4

In this instruction sequence, the first instruction computes a value and writes (i.e., stores) that value to register R0. The second instruction reads the value of R0 and uses that value to compute the value of R3. If this sequence is pipelined, the second instruction may read register R0 before the new value has been stored. In that event, the second instruction uses the wrong value, causing erroneous results. Therefore, it is customary to stall the second instruction long enough for the result of the first instruction to become available.

While the example above shows a RAW dependency for a data register, RAW dependencies may occur with respect to any type of resource, including but not limited to, a data register, an accumulator, a condition code (cc) register (e.g., a one-bit-wide register) and/or a memory location. Such resources may, but need not, reside within the execution pipeline.

Methods currently exist for detecting RAW dependencies and stalling instructions long enough for the results to become available. In one approach, a status bit is maintained for each resource, where each status bit has two possible states: “valid” and “not valid”. The status bit for a resource is set to “not valid” when an instruction that writes to the resource is detected. The status bit is set to “valid” when the instruction is complete or the data (e.g., result) is otherwise available. Instructions that read from a resource are stalled until the status bit for that resource is set to the “valid” state. While stalling is necessary to avoid erroneous results, it degrades performance and should be limited as much as possible.

The amount of time needed for results to become available can vary from processor to processor, and even instruction to instruction. Complex combinatorial logic circuits are often needed to determine when the data is available and to set the status bit to “valid”.

Thus, notwithstanding the level of performance provided by current methods and apparatus, there is a need for enhanced methods and apparatus for managing read-after-write dependencies in pipelined digital processors.

### SUMMARY OF THE INVENTION

According to one aspect of the present invention, a method is provided for use in a digital processor having a pipeline for executing instructions. The method comprises monitoring instructions in the pipeline for instructions that write to a resource and instructions that read from the resource; for each instruction that writes to the resource, storing a write instruction type and write instruction tracking data; for each instruction that reads from the resource, determining a read instruction type and generating a latency value based on the write instruction type and the read instruction type; and stalling execution of the instruction that reads from the resource by a number of stall cycles in response to the latency value and the write instruction tracking data.

According to another aspect of the present invention, apparatus is provided for use in a digital information processor having a pipeline for executing instructions. The apparatus comprises means for monitoring instructions in the pipeline for instructions that write to a resource and instructions that read from the resource, for supplying a write instruction type for each instruction that writes to the resource, and for supplying a read instruction type for each instruction that reads from the resource; means for storing write instruction tracking data for each instruction that writes to the resource; means for generating a latency value based on the write instruction type and the read instruction type; and means for stalling execution of the instruction that reads from the resource by a number of stall cycles in response to the latency value and the write instruction tracking data.

According to another aspect of the present invention, apparatus is provided for use in a digital processor having a pipeline for executing instructions. The apparatus comprises a decoder circuit to receive instructions in the pipeline that will write to a resource and read from the resource, to supply a write instruction type for each instruction that writes to the resource, and to supply a read instruction type for each instruction that reads from the resource; a write tracking circuit to store write instruction tracking data for each instruction that writes to the resource; a latency data generator circuit to supply a latency value based on the write instruction type and the read instruction type; and a stall signal circuit to receive the latency value and the write instruction tracking data and to supply a signal to stall the execution of the instruction that reads from the resource by a number of stall cycles in response to the latency value and the write instruction tracking data.

According to another aspect of the present invention, a method is provided for use in a digital processor having a pipeline for executing instructions. The method comprises monitoring instructions in the pipeline for instructions that write to one or more resources and instructions that read from one or more resources; for each instruction that writes to one or more resources, storing at least one write instruction type and write instruction tracking data; for each instruction that reads from one or more resources, determining at least one read instruction type and generating at least one latency value based on the at least one write instruction type and the at least one read instruction type; and stalling execution of the instruction that reads from one or more resources by a number of cycles in response to the at least one latency value and the write instruction tracking data.

Notwithstanding any potential advantages of one or more embodiments of one or more aspects of the present invention, it should be understood that there is no absolute requirement that any embodiment of any aspect of the present invention address the shortcomings of the prior art.

### BRIEF DESCRIPTION OF THE DRAWINGS

FIG. 1 is a schematic diagram of a digital processor pipeline in which a data dependency manager according to one embodiment of the present invention is used;

FIG. 2 is a block diagram of one embodiment of the data dependency manager circuit of FIG. 1;

FIG. 3 is a schematic diagram of a look-up table used in one embodiment of the latency unit of FIG. 2;

FIG. 4 is a schematic diagram of one embodiment of the pending write tracking unit of FIG. 2;

FIG. 5A is a schematic diagram of a shift register format used in the cycles-to-commit table of FIG. 4C;

FIG. 5B is a schematic diagram of the state of a shift register for the case where an instruction will write to the associated resource in seven cycles;

FIG. 5C is a schematic diagram of the state of a shift register for the case where there are no pending instructions that will write to the associated resource;

FIG. 6 is a schematic diagram of one embodiment of a shift register used in the cycles-to-commit table of FIG. 4C;

FIG. 7A is a schematic diagram of one embodiment of the stall duration generator used in the data dependency manager of FIG. 2;

FIG. 7B is a schematic diagram of one embodiment of the shift unit shown in FIG. 7A;

FIG. 7C is a table that shows one embodiment of a relationship between the latency value and the output result of the shift unit;

FIGS. 8A-8F are schematic diagrams that show successive states of the pipeline of FIG. 1 for an example of an instruction sequence; and

FIG. 9 is a block diagram of another embodiment of the data dependency manager circuit of FIG. 1.

### DETAILED DESCRIPTION

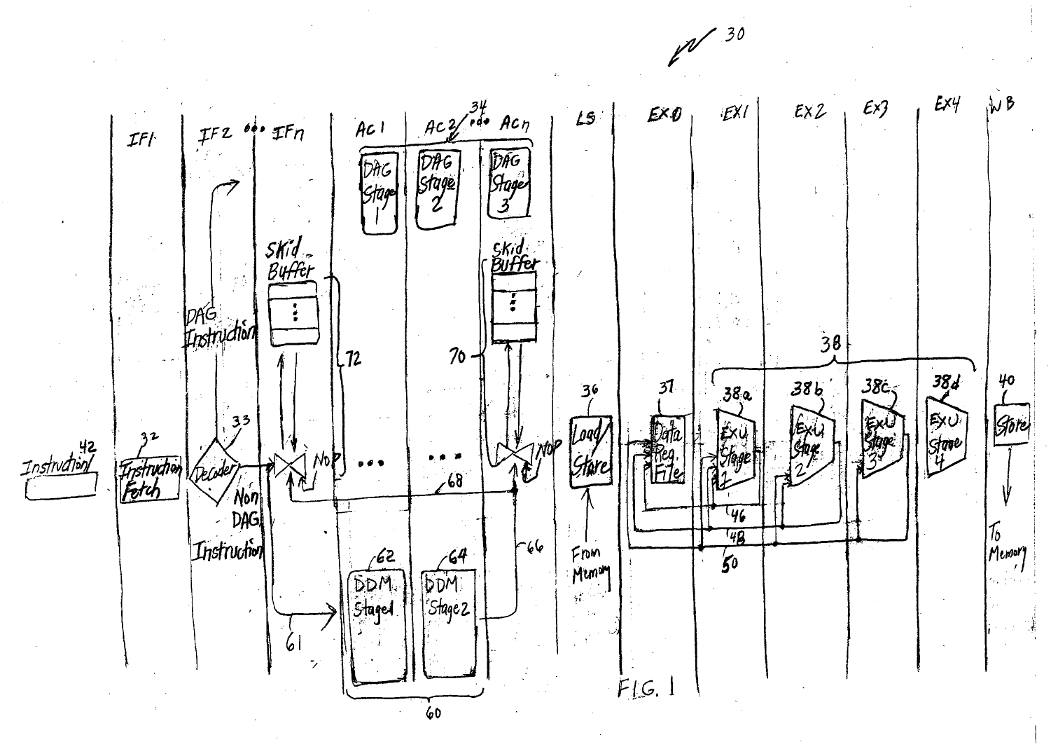

FIG. 1 shows an example of a digital processor having a pipeline 30 that uses a data dependency manager circuit (referred to hereafter as a data dependency manager or DDM) according to one embodiment of the present invention. The pipeline 30, which is divided into a series of stages, i.e., IF1, IF2, IFn, AC1, AC2, ACn, LS, EX0, EX1, EX2, EX3, EX4 and WB, includes an instruction fetch unit 32, an instruction decoder unit 33, a data address generator (DAG) 34, a data load/store unit 36, a data register file 37, an execution unit 38, and a store unit 40. The pipeline 30 may be configured as a single monolithic integrated circuit, but is not limited to such.

In operation, instructions are loaded into pipeline 30 and proceed through the pipeline on successive clock cycles. In particular, in the IF1 stage, an instruction 42 is fetched from memory or from an instruction cache by instruction fetch unit 32. In IF2 stage, instruction 42 is decoded by instruction decode unit 33 and is identified as a DAG instruction (i.e., an instruction that requires the DAG) or a non-DAG instruction (i.e., an instruction that does not require the DAG). If instruction 42 is a DAG instruction, DAG 34 generates addresses of data to be accessed, and the addresses are supplied to load/store unit 36. If the instruction is a not a DAG instruction, instruction decoder 33 outputs a decoded instruction that eventually reaches load/store unit 36 and execution unit 38.

In the LS stage, addresses generated by DAG 34 (and/or other signals that identify the source of operands) are supplied to load/store unit 36, which loads data in response thereto. In the EX0 stage, such data is supplied to data register file 37. In the EX1-EX4 stages, execution unit 38 receives and executes instructions, as appropriate. In the WB stage, store unit 40 stores (writes) the result(s) from execution unit 38 to memory or another designated resource, thereby completing execution of instruction 42.

The execution unit 38 has n execution stages, four of which are shown: EXU stage 38a, EXU stage 38b, EXU stage 38c, and EXU stage 38d. Each of the execution stages may be associated with a particular stage of the pipeline. For example, EXU stage 38a may be associated with pipeline stage EX1, EXU stage 38b may be associated with pipeline stage EX2, etc. In this embodiment, EXU stage 38a performs add operations, EXU stage 38b performs multiply operations, EXU stage 38c performs shift operations, and EXU stage 38d performs logic operations. Other execution stages may, for example, carry out the same or different operation(s).

The execution unit 38 further includes datapaths 46, 48, 50, which are used to move results from one execution stage to another. This is sometimes referred to as “forwarding”. Forwarding makes the result of an instruction available before the result has actually been written in the WB stage (i.e., before the instruction is complete). The WB stage is discussed below. In practice, the processor may include many such datapaths. In the embodiment of FIG. 1, the datapath 46 forwards the output of EXU stage 38a to the input of EXU stage 38a and to the input of data register file 37. The datapath 48 forwards the output of EXU stage 38b to the inputs of EXU stage 38b, EXU stage 38a and data register file 37. The datapath 50 forwards the output of EXU stage 38c to the inputs of EXU stage 38c, EXU stage 38b, EXU stage 38a and data register file 37.

As stated previously, it is important to detect RAW dependencies and to stall instructions that read from a resource to insure that the instruction does not read the data from the resource before the data is updated by an earlier write instruction. In order to accomplish this, pipeline 30 is provided with a data dependency manager 60 (referred to hereafter as DDM 60). The DDM 60 monitors the instructions in pipeline 30 to identify (a) pending instructions that write to one or more resources, and (b) pending instructions that read from one or more resources. The DDM 60 receives the instructions via signal line(s), represented by a signal line 61. The phrase “instructions that read from a resource” is meant to include: (1) instructions that receive data from the resource, and (2) instructions that receive data by forwarding (i.e., data that is generated for the resource but not yet stored in the resource). Hereinafter, an instruction that writes to one or more resources is sometimes referred to as a “write instruction”. An instruction that reads from one or more resources is sometimes referred to as a “read instruction”. Some instructions can (1) read operands and (2) write results. Such instructions can be viewed as both a read instruction and a write instruction.

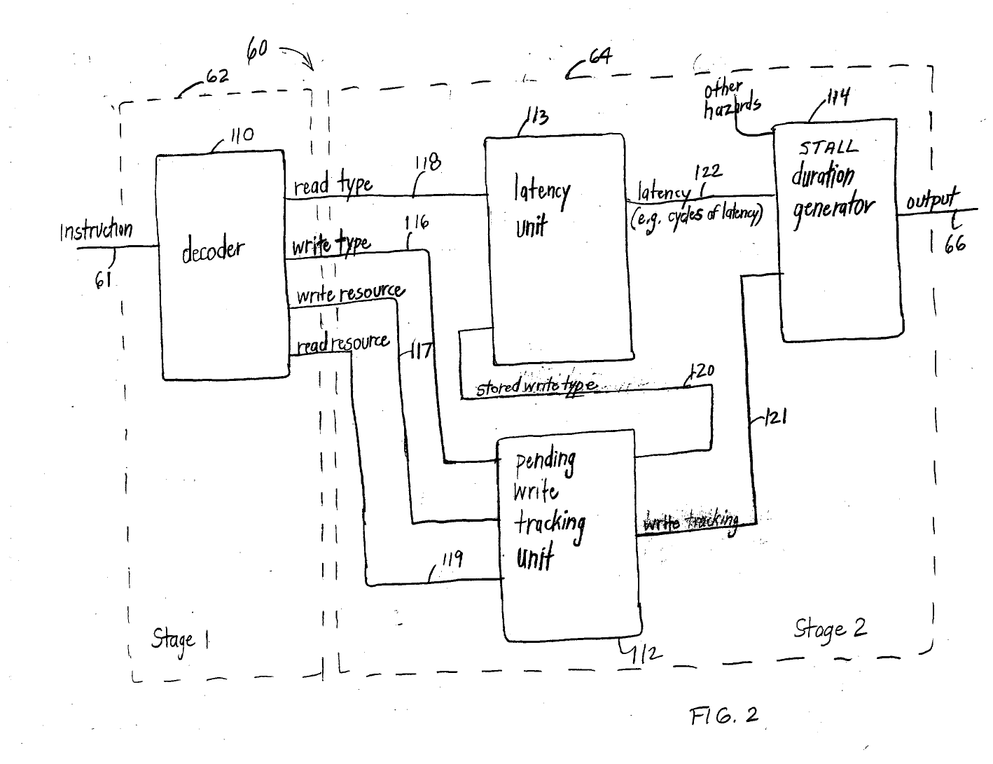

When DDM 60 detects a pending read instruction, DDM 60 determines whether this instruction needs to be stalled. The manner in which DDM 60 makes this determination is discussed below with reference to FIGS. 2-4. If there is a need to stall a read instruction, DDM 60 generates control signals on signal line(s), represented by a signal line 66, that cause the instruction to be diverted out of the main flow of the pipeline and into a buffer 70 (e.g., a bank of registers, sometimes referred to as a skid buffer). The instruction remains in buffer 70 for an appropriate number of cycles, after which the instruction exits buffer 70 and resumes its course through pipeline 30. The buffer 70 is typically a first-in first-out (i.e., FIFO) buffer, meaning that the first instruction diverted into buffer 70 is also the first instruction out of buffer 70. The DDM 60 may also generate control signals 68 that stall upstream instructions (by diverting such instructions into an upstream skid buffer 72), so as to limit the number of instructions that need to be stored in buffer 70. The DDM 60 may also generate control signals (not shown) to prevent additional instructions from being loaded into pipeline 30.

The DDM 60 shown in FIG. 1 includes a DDM stage 62 and a DDM stage 64. DDM stage 62 is positioned in the AC1 stage of pipeline 30, and DDM stage 64 is positioned in the AC2 stage of pipeline 30. Positioning DDM 60 in these stages makes it possible to stall read instructions ahead of the LS stage (the load/store stage). This in turn makes it easier to handle the overhead associated with stalling instructions. For example, if the read instructions were stalled after the LS stage, then additional buffers would be needed to store the data associated with stalled instructions. Notwithstanding this advantage, there is no requirement to position DDM 60 in the AC stages, or even upstream of the load/store stage.

FIG. 2 is a block diagram of one embodiment of DDM 60. This embodiment of DDM 60 includes DDM stage 62 and DDM stage 64. Stage 62 comprises a decoder 110. Stage 64 comprises a pending write tracking unit 112, a latency unit 113, and a stall duration generator 114.

In operation, instructions are supplied to decoder 110 via signal line(s) 61. If the decoder detects a write instruction, then decoder 110 generates two signals: a write resource signal and a write type signal. The write resource signal indicates the resource that is to be written to by the write instruction. The write type signal indicates the write type or category of the write instruction. For example, in this embodiment, instructions that use EXU stage 38a to generate a result that is to be written in a resource are referred to as write type 1. Instructions that use EXU stage 38b to generate a result for the resource are referred to as write type 2. Instructions that use EXU stage 38c to generate a result for the resource are referred to as write type 3, etc.

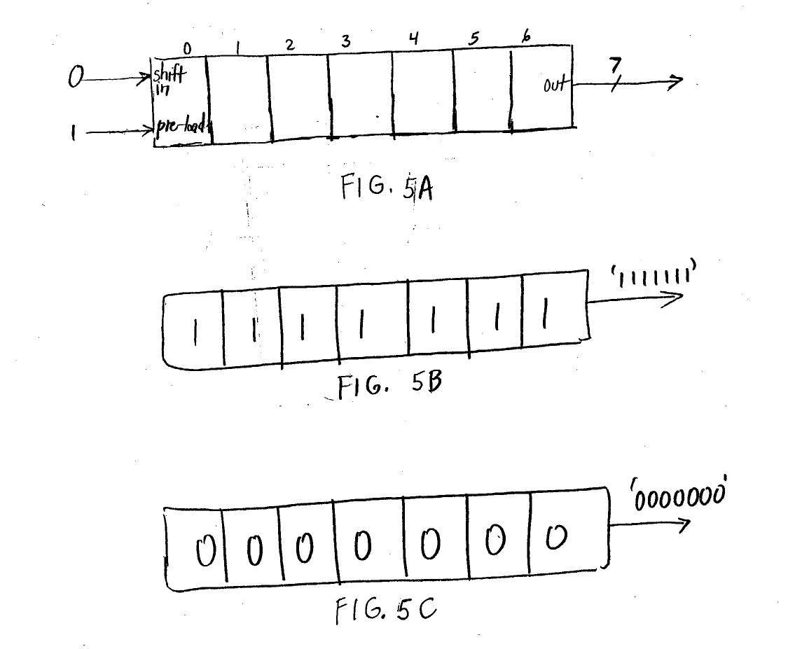

The write type signal and the write resource signal are supplied via signal lines 116, 117, respectively, to pending write tracking unit 112. The write tracking unit 112 tracks the write type and the execution status of the write instruction most recently detected for each resource. In this particular embodiment, pending write tracking unit 112 stores two types of information for each resource: (1) the write type of the write instruction most recently detected for the resource, and (2) write tracking data for the write instruction most recently detected for the resource. The write tracking data may (a) determine the position of a write instruction within the pipeline, (b) determine whether the write portion of the write instruction is complete, and/or (c) determine the number of cycles remaining until the write portion of the write instruction is complete. In this embodiment, the write tracking data represents the number of cycles needed to complete the write portion of the write instruction (referred to herein as the cycles-to-commit). The write tracking data is typically updated as the instruction advances through the pipeline. One embodiment of pending write tracking unit 112 is described below with reference to FIG. 5.

If decoder 110 detects a read instruction, decoder 110 generates a read resource signal and a read type signal. The read resource signal indicates the resource that will be read by the read instruction. The read type signal indicates the read type or category of the read instruction. For example, in this embodiment, instructions that read a resource to obtain an operand for EXU stage 38a are referred to as read type 1. Instructions that read a resource to obtain an operand for EXU stage 38b are referred to as read type 2. Instructions that read a resource to obtain an operand for EXU stage 38c are referred to as read type 3.

The read type signal is supplied via a signal line 118 to latency unit 113, which is described below. The read resource signal is supplied via a signal line 119 to pending write tracking unit 112. The pending write tracking unit 112 responds by providing information regarding the most recently detected write instruction for the read resource. In this particular embodiment, pending write tracking unit 112 supplies two signals: (1) a stored write type signal, and (2) a write tracking signal. The stored write type signal indicates the write type of the write instruction most recently detected for the resource identified in the read instruction. The write tracking signal indicates the number of cycles needed to complete the write portion of the write instruction most recently detected for the resource identified in the read instruction. The write tracking signal is supplied on signal line 121 to stall duration generator 114, which is described below. The stored write type signal is supplied on signal line 120 to latency unit 113, which as stated above, also receives the read type signal on signal line 118.

The latency unit 113 stores data that indicates the required latency (or delay) between various types of write instructions and various types of read instructions. For example, in this particular embodiment, the latency unit 113 stores data that indicates the required delay between a write instruction of write type 1 and a read instruction of read type 1. The latency unit 113 also stores data that indicates the required delay between a write instruction of write type 1 and a read instruction of read type 2, etc. The latency unit 113 may be implemented as one or more look-up tables. One embodiment of latency unit 113 is discussed below with reference to FIG. 3.

The latency unit 113 outputs a latency signal that indicates the required latency between the type of write instruction most recently detected for the resource to be read and the type of read instruction that is to read from the resource. The latency may be expressed in terms of clock cycles or any other suitable unit(s) of measure.

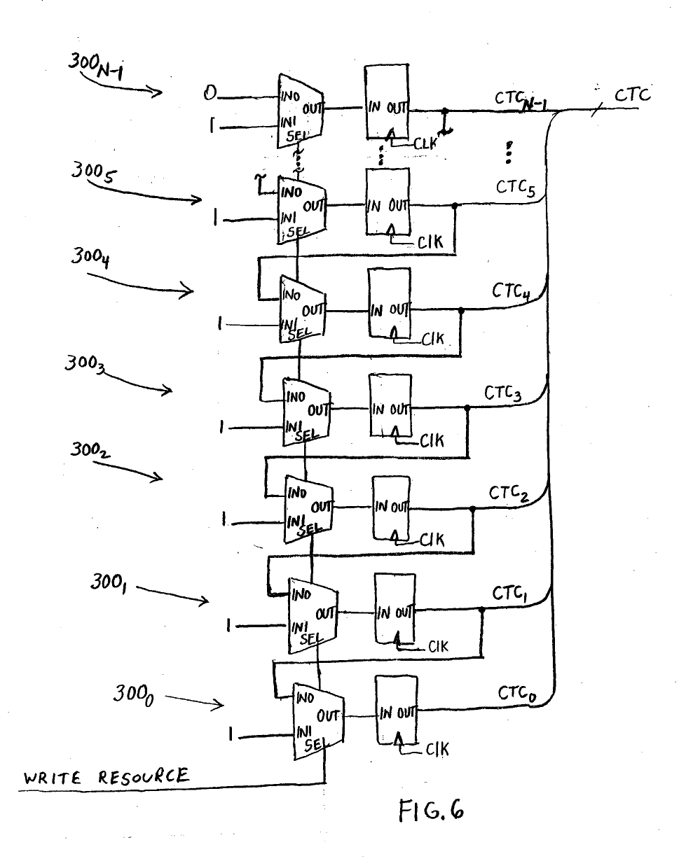

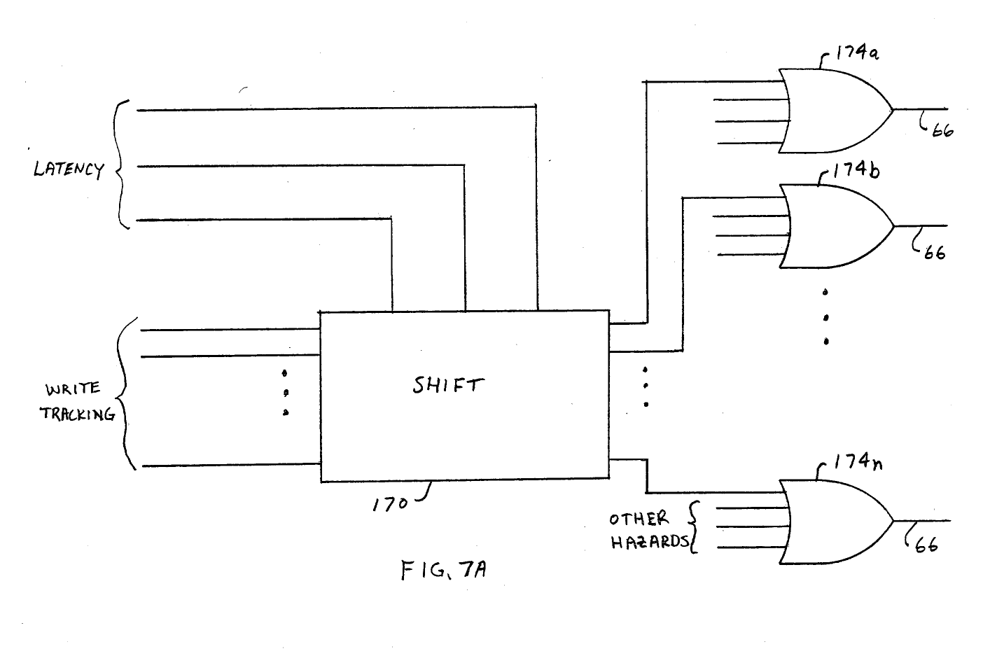

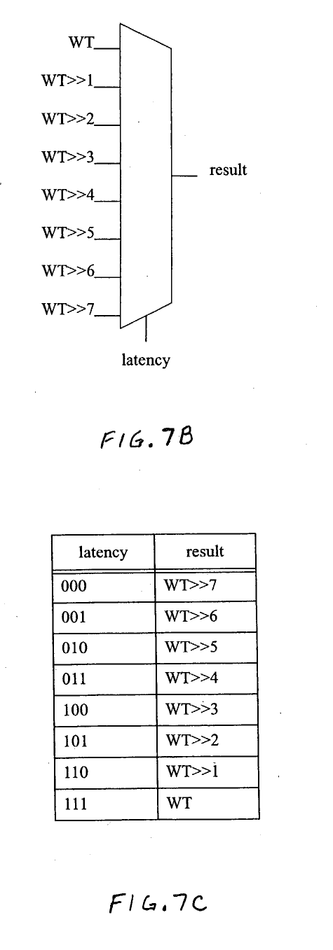

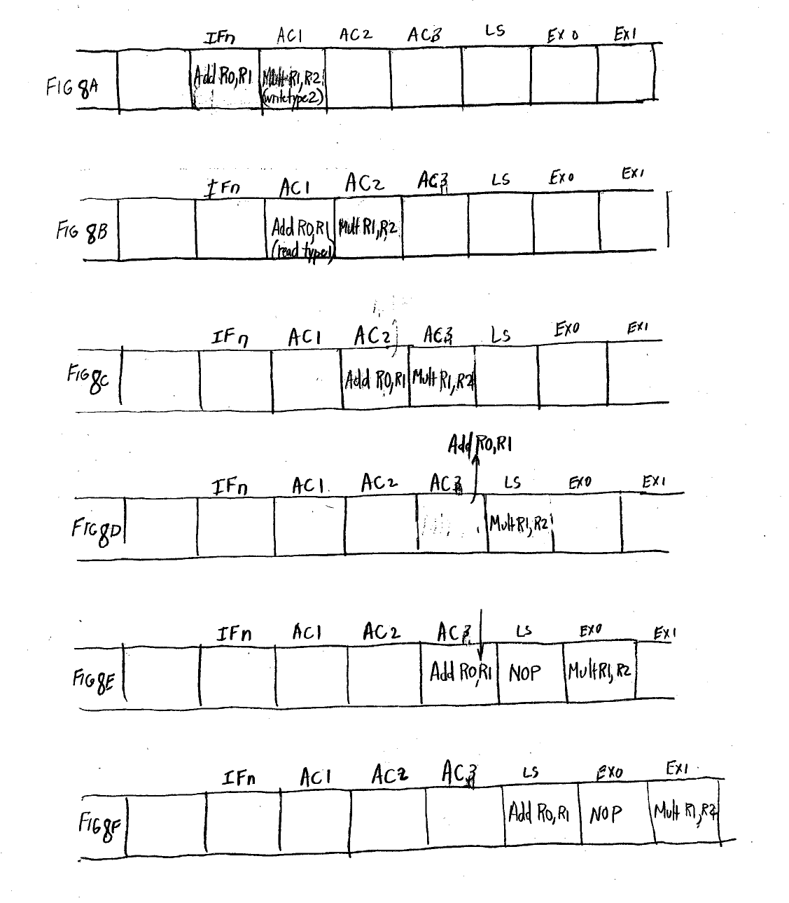

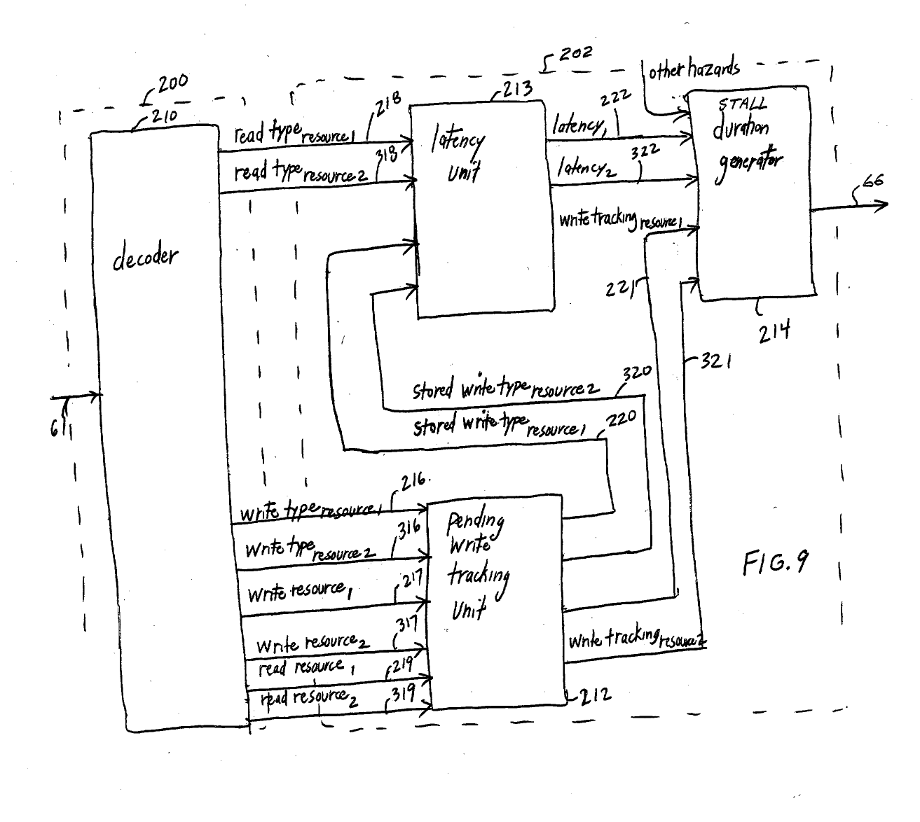

The latency signal is supplied on a signal line 122 to stall duration generator 114, which also receives the write tracking signal. The stall duration generator 114 responds by determining an appropriate number of cycles to stall the read instruction. An output signal indicating the appropriate number of stall cycles is supplied on signal line 66. One embodiment of the stall duration generator is described below with reference to FIGS. 7A-7C.

FIG. 3 shows one embodiment of a look-up table for latency unit 113. This look-up table accommodates n write types (i.e., n types of write instructions) and m read types (i.e., m types of read instructions). In this embodiment, write type 1 refers to instructions that generate results from EXU stage 38a (which in this embodiment performs add operations). Write type 2 refers to instructions that generate results from EXU stage 38b (which in this embodiment performs multiply operations). Write type 3 refers to instructions that generate results from EXU stage 38c (which in this embodiment performs shift operations). Write type 38d refers to instructions that generate results from EXU stage 38d (which in this embodiment performs shift operations). Likewise, read type 1 refers to instructions for which operands are to be supplied to EXU stage 38a. Read type 2 refers to instructions for which operands are to be supplied to EXU stage 38b. Read type 3 refers to instructions for which operands are to be supplied to EXU stage 38c. Read type 4 refers to instructions for which operands are to be supplied to EXU stage 38d.

Each value in the look-up table represents the required latency (expressed as a number of clock cycles) between a particular type of write instruction and a particular type of read instruction (referred to herein as a “write type-read type combination”). For example, the latency between write type 1 and read type 1 (i.e., a “write type 1-read type 1 combination”) is equal to one clock cycle. The latency between write type 1 and read type 2 is equal to zero. The latency between write type 1 and read type 3 is also equal to zero, and the latency between write type 1 and read type four clock cycles. The latencies between write type 4 and read types 1, 2, and 3, are all equal to seven clock cycles.

In this embodiment, each location in the look-up table contains three bits, thus permitting latencies of 0-7 clock cycles to be represented. Different pipeline architectures may require different numbers of bits in the look-up table and may require different latency values. In this embodiment, the values in the table are fixed and the look-up table may therefore be implemented as a read-only memory (ROM) or programmable (read-only-memory), although this is not a requirement of the present invention.

One methodology for generating a latency value for a particular write type-read type combination in pipeline 30 (FIG. 1) is as follows. If the result to be written (by the write instruction) is generated upstream of the pipeline stage where the result is to be supplied (to the read instruction), there is no need to stall the read instruction, and the latency value is set equal to zero. Otherwise, the latency value depends on whether a forwarding path is provided between the pipeline stage where the result is generated and the pipeline stage where the result is supplied. If a forwarding path is provided, then the latency value is set equal to the delay through that forwarding path. If a forwarding path is not provided, then the latency value is set equal to seven clock cycles (i.e., the number of pipeline stages between the read of the register and the write of the register, which happens at the end of the pipeline in this embodiment), so that the read instruction is stalled long enough to complete the write portion of the write instruction. It will be understood that latency values in a particular application depend on the pipeline depth and configuration.

Examples of implementations of the above methodology are provided below. It is assumed that the delays through datapaths 46, 48, 50 are as shown in Table 1 below.

TABLE 1

| TABLE | | FROM | TO | DELAY |
|---|---|---|---|---|
| ENTRY | DATAPATH | OUTPUT OF | INPUT OF | CYCLES |
| 1 | 46 | EXU stage 38a | Data Reg File | 2 |
| 2 | 46 | EXU stage 38a | EXU stage 38a | 1 |
| 3 | 48 | EXU stage 38b | Data Reg File | 3 |
| 4 | 48 | EXU stage 38b | EXU stage 38a | 2 |
| 5 | 48 | EXU stage 38b | EXU stage 38b | 1 |
| 6 | 50 | EXU stage 38c | Data Reg File | 4 |
| 7 | 50 | EXU stage 38c | EXU Stage 38a | 3 |
| 8 | 50 | EXU stage 38c | EXU stage 38b | 2 |
| 9 | 50 | EXU stage 38c | EXU stage 38c | 1 |

### EXAMPLE 1

### Latency Between Write Type 1 and Read Type 1

As the look-up table of FIG. 3 indicates, the latency between write type 1 and read type 1 is equal to one clock cycle. The rationale is as follows. The result to be stored (by the write instruction) is provided at the output of stage 38a. This result is to be supplied (per the read instruction) to the input of stage 38a. Because the input to stage 38a is upstream of the output of stage 38a, the latency depends on whether is a forwarding path is provided. In this embodiment, there is a forwarding path is provided between the output of stage 38a and the input of stage 38a (see datapath 46), and the delay through that path is one clock cycle (see entry 2 in Table 1).

### EXAMPLE 2

### Latency Between Write Type 1 and Read Type 2

The look-up table of FIG. 3 indicates that the latency between write type 1 and read type 2 is equal to 0. The rationale is as follows. The result to be stored (by the write instruction) is provided at the output of stage 38a. This result is to be supplied (per the read instruction) to the input of stage 38b. Because the result is generated upstream of the stage where it is to be supplied, the latency is set equal to zero.

### EXAMPLE 3

### Latency Between Write Type 4 and Read Type 1

The look-up table of FIG. 3 indicates that the latency between write type 4 and read type 1 is equal to seven clock cycles. The rationale is as follows. The result to be stored (by the write instruction) is provided at the output of stage 38d. This result is to be supplied (per the read instruction) to the input of stage 38a. Because the input to stage 38a is upstream of the output of stage 38d, the latency depends on whether a forwarding path is provided. In this embodiment, no forwarding path is provided between stage 38d and any other stage. Thus, the latency is set equal to seven clock cycles (i.e., the number of pipeline stages between the read of the register and the write of the register, which happens at the end of the pipeline in this embodiment), so that the read instruction is stalled long enough to complete the write portion of the write instruction.

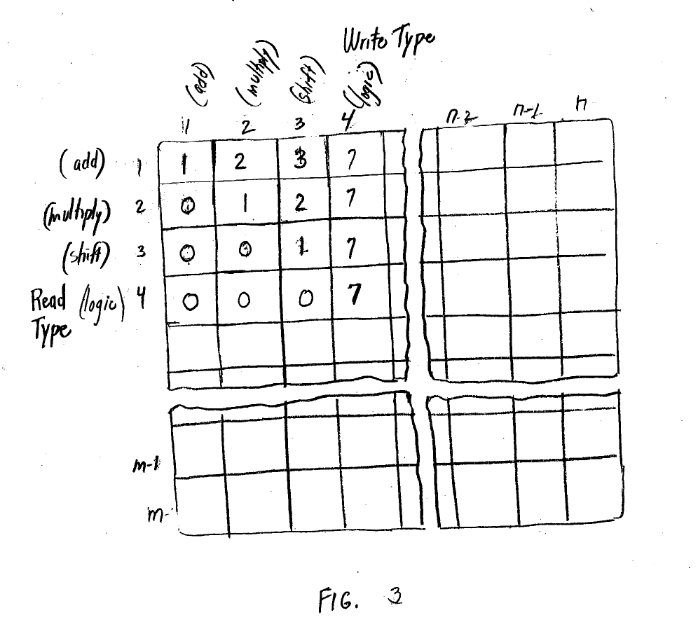

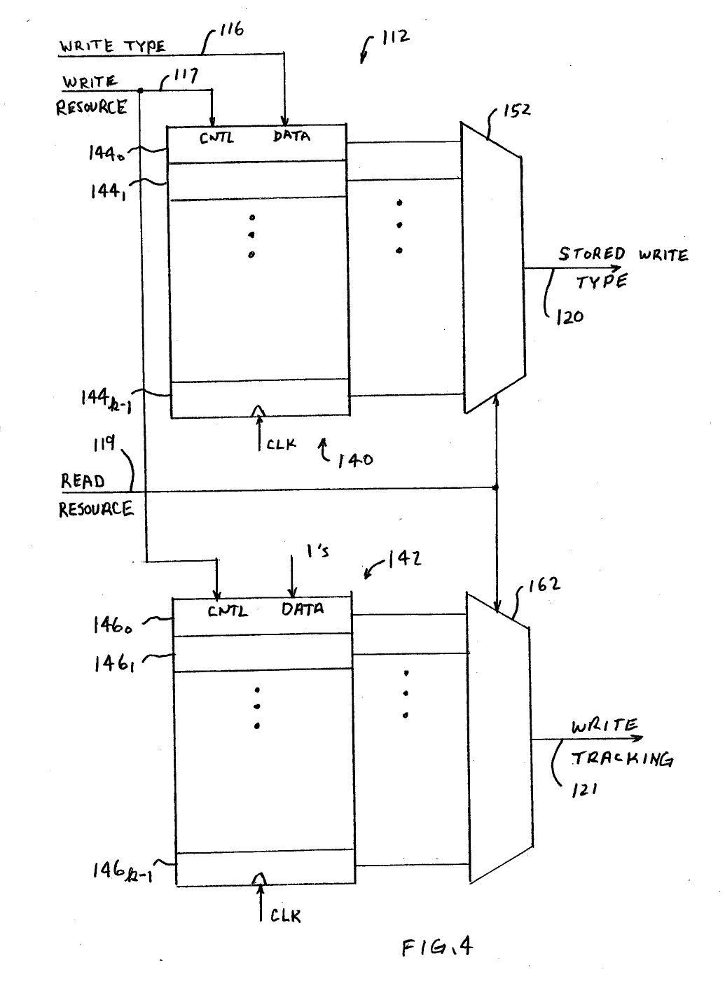

FIG. 4 shows one embodiment of pending write tracking unit 112 of FIG. 2. In this embodiment, pending write tracking unit 112 includes a pending write type table 140 and a cycles-to-commit table 142. The pending write type table 140 includes a plurality of multi-bit registers 144₀-144ₖ₋₁ and a multiplexer 152. Each of the registers 144₀-144ₖ₋₁ corresponds to a respective one of the resources to be supported by DDM 60 (FIG. 1). For example, register 144₀ corresponds to resource 0. Register 144ₖ₋₁ corresponds to resource k−1. Similarly, the cycles-to-commit table 142 includes a plurality of multi-bit registers 146₀-146ₖ₋₁ and a multiplexer 162. Each of the registers 146₀-146ₖ₋₁ corresponds to a respective one of the resources to be supported by DDM 60. For example, register 146₀ corresponds to resource 0. Register 146ₖ₋₁ corresponds to resource k−1.

The write resource signal from decoder 110 (FIG. 2) is coupled to control inputs of registers 144₀-144ₖ₋₁, and the write type signal from decoder 110 is coupled to data inputs of registers 144₀-144ₖ₋₁. When a write instruction is detected, the multi-bit register that corresponds to the resource to be written is selected by the write resource signal and the write type of the write instruction is written in the selected register.

The outputs of multi-bit registers 144₀-144ₖ₋₁ are supplied to respective inputs of multiplexer 152. The multiplexer 152 has an output that supplies the write type signal on signal line 120. Multiplexer 152 is controlled by the read resource signal on signal line 119. When a read instruction is detected, multiplexer 152 outputs the write type of the write instruction most recently detected for the resource to be read.

The write resource signal from decoder 110 (FIG. 2) is coupled to control inputs of registers 146₀-146ₖ₋₁, and logic “1” is coupled to data inputs of registers 146₀-146ₖ₋₁. When a write instruction for a resource is detected, the multi-bit register that corresponds to the resource to be written is selected by the write resource signal and the selected register is initialized to all 1's, as further discussed below with respect to FIG. 5A. The outputs of registers 146₀-146ₖ₋₁ are supplied to respective inputs of multiplexer 162. The multiplexer 162 has an output that supplies the write tracking signal on signal line 121. Multiplexer 162 is controlled by the read resource signal on signal line 119. When a read instruction for a resource is detected, multiplexer 162 outputs the number of cycles needed to complete the write portion of the write instruction most recently detected for the resource to be read.

Each of the registers 146₀-146ₖ₋₁ in cycles-to-commit table 142 is preferably a shift register. FIG. 5A shows one embodiment of a shift register that may be used. In this embodiment, the number of bits in the shift register is seven, i.e., the number of stages between the read of the register and the write of the register, which happens at the end of the pipeline in this embodiment). The number of 1's in the shift register indicates the number of cycles that remain until a pending write instruction writes a result in the resource. If DDM 60 detects a write instruction, all of the bits in the associated shift register are set to 1. With each clock cycle, the entry in each register is shifted one bit to the right (a 0 is shifted into the leftmost bit). This reduces the number of 1's in the shift register and indicates that the write instruction is one cycle closer to reaching the end of the pipeline. A bit sequence of “1111111” signifies that seven cycles are needed for the write instruction to reach the end of the pipeline (see FIG. 5B). A bit sequence of “0000000” signifies that the write instruction has reached the end of the pipeline and is no longer pending (see FIG. 5C).

FIG. 6 shows one embodiment of the shift registers used in the cycles-to-commit table 142. In this embodiment, each shift register includes N stages (one for each bit in the shift register), seven of which are shown, i.e., 300₀, 300₁, 300₂, 300₃, 300₄, 300₅, 300_{N-1}. Each of the stages 300₀-300_{N-1} includes a multiplexer and a latch. The outputs of the latches collectively form the CTC signal. The IN1 input of each multiplexer receives a logic high signal (e.g., 1). The control input of each multiplexer receives the write resource signal. The output of each multiplexer is supplied to the input of the latch for the respective stage. Except for stage 300_{N-1}, the IN0 input of each multiplexer receives the output of the latch of the stage associated with the next most significant bit of the CTC signal. For example, the IN0 input of the multiplexer of stage 300₀ receives the output from the latch of stage 300₁. A logic low signal (e.g., 0) is provided to the IN0 input of the multiplexer of stage 300_{N-1}.

The operation of the shift register is as follows. If the write resource signal is asserted, then each of the stages 300₀-300_{N-1} loads a 1 when the clock goes high. If the write resource signal is not asserted, then the data shifts one bit toward the LSB when the clock goes high.

FIG. 7A shows one embodiment of the stall duration generator 114 of FIG. 2. In this embodiment, the stall duration generator 114 includes a shift unit 170 and OR gates 174a, 174b, . . . 174n. The latency signal is supplied to shift unit 170, which right shifts the write tracking signal by an amount equal to the inverse of the latency value. The number of 1's in the output of shift unit 170 indicates the required number of stall cycles or NOPs to accommodate the read-write data dependency. In this embodiment, the required number of stall cycles to accommodate the data dependency is equal to the latency value from the look-up table minus the number of cycles that the write instruction has advanced when the corresponding read instruction is detected.

The output of shift unit 170 is supplied to OR gates 174a, 174b, . . . 174n, which receive other hazard signals and provide a multi-bit output signal, on signal lines 66, by indicating the required number of stall cycles or NOPs for the RAW dependency or the required number of stall cycles for other hazards, whichever is larger. In this embodiment, the number of 1's in the multi-bit output signal indicates the required number of stall cycles. It should be recognized, however, that the present invention is not limited to this form.

FIG. 7B shows an embodiment of the shift unit 170 of FIG. 7A. Shift unit 170 includes an 8 to 1 multiplexer 180, wherein each of the 8 inputs and the output result are 7 bits. The inputs to multiplexer 180 are the write tracking signal (WT), the write tracking signal right shifted by one bit (WT>>1), the write tracking signal right shifted by two bits (WT>>2), . . . , and the write tracking signal right shifted by seven bits (WT>>7). The right-shifted write tracking signals are obtained by appropriate wiring of the 7-bit write tracking signal to the inputs of multiplexer 180. The control input to multiplexer 180 is the latency value. Multiplexer 180 produces a seven-bit output result. The relationship between the latency value and the output result is shown in the table of FIG. 7C. As noted above, the number of logic 1's in the output result represents the required number of stall cycles.

An example of the operation of one embodiment of DDM 60 is illustrated in FIGS. 8A-8F. In particular, FIGS. 8A-8F show successive states of pipeline 30 with respect to one particular instruction sequence for one embodiment of DDM 60 (FIG. 1). Note that in this example, the number of AC stages in the pipeline 30 (FIG. 1) is three, and DDM 60 is positioned in the AC1 and AC2 stages, as shown in FIG. 1.

Referring to FIG. 8A, which shows a first state of the pipeline, an instruction sequence includes a multiply instruction (in stage AC1) and an add instruction (in stage IFn). This instruction sequence represents a RAW dependency in that the multiply instruction writes a result in register R0, and the add instruction uses the data in register R0 as an operand. DDM 60 determines that the multiply instruction writes to the register R0, and that the multiply instruction is a write type 2.

Referring to FIG. 8B, which shows a second state of the pipeline, the multiply instruction advances to the AC2 stage and the DDM 60 sets the cycles-to-commit register for R0 equal to “1111111” as described above. The add instruction advances to the AC1 stage. The DDM determines that the add instruction reads from register R0, and that the add instruction is a read type 1.

Referring to FIG. 8C, which shows a third state of the pipeline, the multiply instruction advances to the AC3 stage and DDM 60 right shifts the cycles-to-commit register for R0 to “0111111”. The add instruction advances to the AC2 stage. The look-up table of FIG. 3 indicates that a latency of two clock cycles is needed if the write type is 2 and the read type is 1. Therefore, the required number of stall cycles in this embodiment is one, i.e., the latency value minus the number of cycles that the write instruction has advanced when the corresponding read instruction is detected.

Referring to FIG. 8D, which shows a fourth state of the pipeline, the multiply instruction advances to the LS stage. The add instruction advances to the AC3 stage and is diverted into the skid buffer (FIG. 1) for one stall cycle.

Referring to FIG. 8E, which shows a fifth state of the pipeline, the multiply instruction advances to the EX0 stage. A “NOP” is inserted into the pipeline and advances to the LS stage. Because number of stall cycles has expired, the add instruction exits the skid buffer and returns to the AC3 stage.

Referring to FIG. 8F, which shows a sixth state of the pipeline, the multiply instruction advances to the EX1 stage. The “NOP” advances to the EX0 stage. The add instruction advances to the LS stage. Execution of all three instructions proceeds without further stall cycles.

Although DDM 60 has been described with respect to a write instruction that writes to one resource and a read instruction that reads from one resource, the present invention is not limited to such.

For example, some embodiments employ read instructions that have more than one operand and therefore read from more than one resource. Read-after-write dependencies may occur with respect to any of the resources. Thus, it is desirable to stall the read instruction long enough to ensure that the read instruction does not read any of the data too soon.

Similarly, some embodiments employ write instructions that write to more than one resource. For example some instructions generate a result and then write that result in multiple resources. Moreover, some embodiments employ write instructions that have more than one write type, meaning that results are generated at more than one execution stage.

For example, some instructions may initiate multiple operations to produce multiple results, each of which may be written in a different resource. If one of the results is generated by EXU stage 38a and another one of the results is generated by EXU stage 38b then the instruction can be viewed as being write type 1 with respect to the first result and write type 2 with respect to the second result.

Similarly, read instructions may have more than one read type meaning that the instruction reads data from more than one execution stage. For example, an instruction may read two resources. If the data from one resource is supplied to EXU stage 38a and the data from the second resource is supplied to EXU stage 38b, then the instruction can be viewed as being read type 1 with respect to the first resource and read type 2 with respect to the second resource.

FIG. 9 is a block diagram of another embodiment of DDM 60 (FIG. 1). In this embodiment, DDM 60 accommodates: (1) write instructions that write to up to two resources, and (2) read instructions that read from up to two resources. This embodiment of the DDM includes stages 200 and 202. The first stage 200 includes a decoder 210. The second stage 202 includes a pending write tracking unit 212, a latency unit 213 and a stall duration generator 214.

In operation, instructions are supplied to decoder 210 via signal line(s) 61. If the decoder detects a write instruction, then decoder 210 generates at least two signals: (1) a write resource₁, signal, and (2) a write type_{resource1} signal. The write resource₁ signal indicates a first resource that is to be written to by the write instruction. The write type_{resource1} signal indicates the write type or category of the write instruction with respect to the first resource. If the decoder determines that the write instruction writes to more than one resource, then decoder 210 generates two more signals: (1) a write resource₂ signal, and (2) a write type_{resource2} signal. The write resource₂ signal indicates the second resource that is to be written to by the write instruction. The write type_{resource2} signal indicates the write type or category of the write instruction with respect to the second resource.

The write type_{resource1}, write type_{resource2}, write resource₁ and write resource₂ signals are supplied via signal lines 216, 316, 217, 317, respectively, to pending write tracking unit 212. The pending write tracking unit 212 tracks the write type and the execution/completion status of the write instruction most recently detected for each resource. As with pending write tracking unit 112 shown in FIG. 2 and described above, pending write tracking unit 212 stores two types of information for each resource: (1) the write type of the write instruction most recently detected for the resource, and (2) write tracking data for the write instruction most recently detected for the resource. The write tracking data may, for example, represent the number of cycles needed to complete the write portion of the write instruction. The write tracking data is typically updated as the instruction advances through the pipeline.

When decoder 210 detects a read instruction, decoder 210 generates at least two signals: (1) a read resource₁ signal, and (2) a read type_{resource 1} signal. The read resource, signal indicates a first resource that will be read by the read instruction. The read type_{resource 1} signal indicates the read type or category of the read instruction with respect to the first resource. If decoder 210 determines that the read instruction reads from more than one resource, then decoder 210 generates two more signals: (1) a read resource₂ signal, and (2) a read type_{resource 2} signal. The read resource₂ signal indicates a second resource that is to be read by the read instruction. The read type_{resource 2} signal indicates the read type or category of the read instruction with respect to the second resource.

The read type_{resource 1} and read type_{resource 2} signals are supplied via signal lines 218, 318, respectively, to the latency unit 213. The read resource₁ and read resource₂ signals are supplied via signal lines 219, 319, respectively, to pending write tracking unit 212. The pending write tracking unit 212 responds by providing information regarding the most recently detected write instruction for the resource(s) to be read by the read instruction. In this particular embodiment, pending write tracking unit 212 supplies four signals: (1) a stored write type_{resource1} signal, (2) a write tracking_{resorce1} signal, (3) a stored write type_{resource2} signal and (4) a write tracking_{resource2} signal. The stored write type_{resource1} signal indicates the write type of the write instruction most recently detected for the first resource to be read. The write tracking_{resource1} signal indicates the number of cycles needed to complete the write portion of the write instruction most recently detected for the first resource to be read by the read instruction. If more than one resource is to be read, the stored write type_{resource2} signal indicates the write type of the write instruction most recently detected for the second resource to be read. The write tracking_{resource2} signal indicates the number of cycles needed to complete the write portion of the write instruction most recently detected for the second resource to be read by the read instruction.

The write tracking_{resource1} and the write tracking_{resource2} signals are supplied on signal lines 221, 321, respectively, to stall duration generator 214. The stored write type_{resource1} and the stored write type_{resource2} signals are supplied on signal lines 220, 320, respectively, to latency unit 213, which as stated above, also receives the read type_{resource1} and read type_{resource2} signals on signal lines 218, 318, respectively.

The latency unit 213 stores data that indicates the latency (or delay) typically needed between the various types of write instructions and the various types of read instructions. The latency unit 213 may be implemented as one or more look-up tables.

The latency unit 213 outputs at least one signal, latency, which indicates the required latency between the type of write instruction most recently detected for the first resource to be read and the type of read instruction that is to read from the first resource. If more than one resource is to be read by the read instruction, then the latency unit outputs a second signal, latency₂, which indicates the required latency between the type of write instruction most recently detected for the second resource to be read and the type of read instruction that is to read from the second resource.

The latency₁, latency₂ signals are supplied on signal lines 222, 322, respectively, to stall duration generator 214, which as stated above, also receives the write tracking_{resource1}, write tracking_{resource2} signals on signal lines 221, 321, respectively. The stall duration generator 214 responds by determining an appropriate number of cycles to stall the read instruction. An output signal indicating the appropriate number of stall cycles is supplied on signal line 66.

Although various embodiments have been presented for use in association with pipeline 30 of FIG. 1, it should be recognized that the present invention is not limited to such a pipeline. For example, some pipelines have multiply, shift and/or logic units that are not in series with one another. In addition, although pipeline 30 preserves the sequence of the instructions, other pipelines may not. Further, it should be apparent that an instruction does not need to be acted upon in every stage of pipeline 30.

Note that, except where otherwise stated, terms such as, for example, “comprises”, “has”, “includes” and all forms thereof, are considered open-ended SO as not to precluded additional elements and/or features.

Also note, except where otherwise stated, phrase such as, for example, “in response to”, “based on”, “is a function of” and “in accordance with” mean “in response at least to”, “based at least on”, “is a function at least of” and “in accordance with at least”, respectively, so as, for example, not to preclude being responsive to, based on, a function of, or in accordance with more than one thing.

While there have been shown and described various embodiments, it will be understood by those skilled in the art that the present invention is not limited to such embodiments, which have been presented by way of example only, and that various changes and modifications may be made without departing from the spirit and scope of the invention. Accordingly, the invention is limited only by the appended claims and equivalents thereto.

What is claimed is:

1. A method for use in a digital processor having a pipeline for executing instructions, comprising:
monitoring instructions in the pipeline for instructions that write to a resource and instructions that read from the resource;
for each instruction that writes to the resource, storing a write instruction type and write instruction tracking data;
for each instruction that reads from the resource, determining a read instruction type and generating a latency value based on the write instruction type and the read instruction type; and
stalling execution of the instruction that reads from the resource by a number of stall cycles in response to the latency value and the write instruction tracking data.

2. The method of claim 1, wherein storing write instruction tracking data comprises updating said write instruction tracking data every clock cycle.

3. The method of claim 2, wherein storing write instruction tracking data comprises storing write instruction tracking data in a shift register.

4. The method of claim 3, wherein updating said write instruction tracking data comprises shifting the write instruction tracking data in the shift register.

5. The method of claim 4, wherein storing write instruction tracking data comprises storing a cycles-to-commit value in the shift register and updating the cycles-to-commit value every clock cycle by shifting the cycles-to-commit value in the shift register.

6. The method of claim 1, wherein stalling execution of the instruction comprises loading the write instruction tracking data into a shift register, determining a shift amount as a function of the latency value, and shifting the write instruction tracking data in the shift register by said shift amount to provide the number of stall cycles.

7. The method of claim 6, wherein determining the shift amount as a function of the latency data comprises generating a shift amount having a value equal to a bit-by-bit inverse of the latency value.

8. The method of claim 1, wherein stalling execution of the instruction comprises stalling execution of the instruction in accordance with the latency value, the write instruction tracking data, and data indicative of other potential hazards.

9. The method of claim 1, wherein stalling execution of the instruction comprises stalling execution of the instruction by a number of cycles in accordance with the larger of the number of stall cycles and data indicative of other potential hazards.

10. The method of claim 1, further comprising defining a group of write instruction types, wherein storing a write instruction type comprises selecting a write instruction type from the group of write instruction types.

11. The method of claim 1, further comprising defining a group of read instruction types, wherein determining a read instruction type comprises selecting a read instruction type from the group of read instruction types.

12. Apparatus for use in a digital processor having a pipeline for executing instructions, comprising:
means for monitoring instructions in the pipeline for instructions that write to a resource and instructions that read from the resource, for supplying a write instruction type for each instruction that writes to the resource, and for supplying a read instruction type for each instruction that reads from the resource;
means for storing write instruction tracking data for each instruction that writes to the resource;
means for generating a latency value based on the write instruction type and the read instruction type; and
means for stalling execution of the instruction that reads from the resource by a number of stall cycles in response to the latency value and the write instruction tracking data.

13. The apparatus of claim 12, wherein the means for storing write instruction tracking data comprises means for updating said write instruction tracking data every clock cycle.

14. The apparatus of claim 13, wherein the means for storing write instruction tracking data comprises a shift register.

15. The apparatus of claim 14, wherein the means for updating said write instruction tracking data comprises means for shifting the write instruction tracking data in the shift register.

16. The apparatus of claim 15, wherein the means for storing write instruction tracking data stores a cycles-to-commit value in the shift register and updates the cycles-to-commit value every clock cycle.

17. The apparatus of claim 12, wherein the means for stalling execution of the instruction loads the write instruction tracking data into a shift register, determines a shift amount as a function of the latency value, and shifts the write instruction tracking data in the shift register by said shift amount to provide the number of stall cycles.

18. The apparatus of claim 17, wherein the means for stalling execution of the instruction determines the shift amount having a value equal to a bit-by-bit inverse of the latency value.

19. The apparatus of claim 12, wherein the means for stalling execution of the instruction comprises means for generating data representing a number of cycles in accordance with the latency value, the write instruction tracking data, and data indicative of other potential hazards.

20. The apparatus of claim 12, wherein the means for stalling execution of the instruction comprises means for stalling execution of the instruction by a number of cycles in accordance with the larger of the number of stall cycles and data indicative of other potential hazards.

21. The apparatus of claim 12, further comprising means for defining a group of write instruction types, and wherein the means for supplying a write instruction type comprises means for selecting a write instruction type from the group of write instruction types.

22. The apparatus of claim 12, further comprising means for defining a group of read instruction types, and wherein the means for supplying a read instruction type comprises means for selecting a read instruction type from the group of read instruction types.

23. Apparatus for use in a digital processor having a pipeline for executing instructions, the apparatus comprising:
a decoder circuit to receive instructions in the pipeline that write to a resource and read from the resource, to supply a write instruction type for each instruction that writes to the resource, and to supply a read instruction type for each instruction that reads from the resource;
a write tracking circuit to store write instruction tracking data for each instruction that writes to the resource;
a latency circuit to supply a latency value based on the write instruction type and the read instruction type; and
a stall signal circuit to receive the latency value and the write instruction tracking data and to supply a signal to stall the execution of the instruction that reads from the resource by a number of stall cycles in response to the latency value and the write instruction tracking data.

24. The apparatus of claim 23, wherein the write tracking circuit updates said write instruction tracking data every clock cycle.

25. The apparatus of claim 24, wherein the write tracking circuit comprises a shift register to store the write instruction tracking data.

26. The apparatus of claim 25, wherein the write tracking circuit updates said write instruction tracking data by shifting the write instruction tracking data in the shift register.

27. The apparatus of claim 26, wherein the write tracking circuit stores a cycles-to-commit value in the shift register and updates the cycles-to-commit value every clock cycle by shifting the cycles-to-commit value in the shift register.

28. The apparatus of claim 23, wherein the stall signal circuit comprises a shift register to store the write instruction tracking data and the stall signal circuit shifts the write instruction tracking data by a shift amount based on the latency value.

29. The apparatus of claim 28, wherein the stall signal circuit determines the shift amount in accordance with a bit-by-bit inverse of the latency value.

30. The apparatus of claim 23, wherein the stall signal circuit supplies data representing a number of cycles in accordance with the latency value, the write instruction tracking data, and data indicative of other potential hazards.

31. The apparatus of claim 23, wherein the stall signal circuit supplies data representing a number of cycles in accordance with a larger of the number of stall cycles and data indicative of other potential hazards.

32. The apparatus of claim 23, wherein the latency circuit comprises a look-up table having a plurality of locations, each of which contains latency value that corresponds to a write instruction type-read instruction type pair.

33. A method for use in a digital processor having a pipeline for executing instructions, the method comprising:
monitoring instructions in the pipeline for instructions that write to one or more resources and instructions that read from one or more resources;
for each instruction that writes to one or more resources, storing at least one write instruction type and write instruction tracking data;
for each instruction that reads from one or more resources, determining at least one read instruction type and generating at least one latency value based on the at least one write instruction type and the at least one read instruction type; and
stalling execution of the instruction that reads from one or more resources by a number of cycles in response to the at least one latency value and the write instruction tracking data.

34. A method for executing instructions in a pipelined digital processor, comprising:
storing a latency value for a write instruction and a read instruction that access a resource;
maintaining a cycles-to-commit value for the write instruction as the write instruction advances through the pipelined processor; and
modifying the cycles-to-commit value with the latency value to obtain a stall value for stalling the read instruction.

35. A method for executing instructions in a pipelined processor, comprising:
monitoring instructions in the pipelined processor for instructions that write to a resource and instructions that read from the resource;
for each write instruction that accesses the resource, storing a write instruction type and a cycles-to-commit value in a pending write table;
updating the cycles-to-commit value as the write instruction advances through the pipelined processor;
for each read instruction that accesses the resource, determining a latency value based on the write instruction type and the read instruction type;
modifying the cycles-to-commit value by the latency value to provide a required number of stall cycles; and
stalling the read instruction by the required number of stall cycles.
